(19) United States
(12) Patent Application Publication
(10) Pub. No.: US 2005/0138048 A1
(43) Pub. Date: Jun. 23, 2005

(54) XML database duplicating apparatus for copying XML document to remote server without loss of structure and attribute information of XML document and method thereof

(76) Inventors: Ki Sung Jin, Cheonju (KR); June Kim, Taejon (KR); Mi Young Lee, Taejon (KR); Myung Joon Kim, Taejon (KR)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/821,870

(22) Filed: Apr. 12, 2004

(30) Foreign Application Priority Data
Dec. 17, 2003 (KR) 2003-92525

(51) Int. Cl. G06F 7/00

(52) U.S. Cl. 707/100

(57) ABSTRACT

Disclosed is an XML database duplicating apparatus and method capable of providing an effective application service without interruption at a low cost in the diverse Internet environments by copying an XML document of a database system mounting an XML processing technique to another remote server. When the XML document stored in a database of the original server is copied to databases of copied servers, the structure and attribute information included in the XML document are maintained as they are, and thus the respective copied servers can support the searches based on the contents and the attribute provided by an XML query language and disperse users' queries concentrated to the original server to the respective copied servers, so that the service request for application programs can be processed.

### BACKGROUND OF THE INVENTION

1. Field of the Invention

The present invention relates to an XML (eXtensible Markup Language) database duplicating apparatus for copying an XML document to a remote server without loss of structure and attribute information of the XML document and the method thereof, and more particularly, to an XML database duplicating apparatus for copying an XML document to a remote server without loss of structure and attribute information of the XML document and the method thereof that can copy XML data managed by an original database to other servers physically different without loss of not only the original contents of the document but also meanings of the structure and attribute information that the XML document contains.

2. Background of the Related Art

Currently, the XML, which is the next-generation Internet electronic document standard made to remedy defects of an HTML (Hyper Text Markup Language) and an SGML (Standard Generalized Markup Language), has the advantages that it is independent of a platform, enables easy transmission and exchange of information, and represents a substantial meaning of a document as it is. Thus, the application of the XML has gradually been active since it was adopted as a recommendation in W3C in February, 1998. The XML document management system is gradually developing from a system based on a file system to a system based on a database system. This is because as the amount of document being managed becomes larger, the existing database management function such as a prompt search for document, sharing of document among many users, backup and restoration of document against trouble, and so on, is required. At present, many XML document management systems provide the above-described XML management function by using the existing database system. That is, the XML document management system is constructed in a manner that an XML storage for converting the XML document into a data model provided by the database system and storing the converted data model, and an XML document searcher for converting a query language of the XML document into a query language of the database and transferring the database query language to the database system to process the database query language are mounted on the database system.

Meanwhile, as the users' demands for application programs become diverse, the kind and the amount of XML document becomes massive, and thus it is difficult to promptly cope with the users' requests for response in a system that processes all the users' requests through one database server. Especially, in the environment that many users wish real-time services such as E-business and portal service, the system performance becomes deteriorated to cause the process for the users' demands to be delayed. Further, if an abnormal situation is created in the server and the service being provided is interrupted, this would cause the loss of the users' trust, and the service provider would suffer great losses.

In order to solve the problems of the single-server database as described above, techniques such as database clustering and database duplicating have been developed.

In the case of the database clustering technique, the service is provided in a state that a plurality of servers are logically combined, and this enables not only data abruptly increasing in the Internet environment to be promptly processed but also the service to be provided without interruption using an active server in the cluster even in the environment that the system cannot operate normally such as system trouble. However, this method not only requires expensive equipment in order to construct the clustering environment but also has the limit of a signal point failure due to regional obstacles, and thus it is difficult to apply the method to diverse types of the Internet services.

Accordingly, as a method for providing effective application services without interruption at a low cost in the Internet environment, a database duplicating technique for providing application services using databases copied to a plurality of servers rather than the single-database system is now required.

The oracle DBMS (Database Management System) initially adopted a method of providing a snapshot in a manner that a copied server copies data of the original server at a given time point and reflecting changed data in a copied database for a time period or according to a request. Thereafter, the oracle DBMS has managed duplicated data by proving a symmetric replication. According to this, the original server maintains the synchronization of the changed data by transmitting the changed data to the copied server by trigger or a stored procedure, and provides a dynamic ownership that can be changed only in one server at a given time point and a shared ownership that can be simultaneously changed in multiple servers. The oracle DBMS can designate an object of replication in the unit of a database table. Since types of fields that constitute the table subject to replication are limited to VARCHAR, NUMBER, DATE, TIMESTAMP, RAW, RAWID, CHAR, BLOB, CLOB AND NCLOB, the duplication of the XML document can be performed through a user's direct preparation of an application program. In this case, however, it is difficult to perform the replication without any loss of structure and attribute information of the XML document, and this may cause any inefficient results.

Microsoft SQL-server provides a technique of copying the database stored in the original server to other servers physically different by providing diverse database replication types such as snapshot replication, transaction replication, combined replication, and so on. However, the technique has problems that it permits the replication only with respect to a table of a general data type such as the oracle DBMS, but it cannot perform the replication of the XML document.

### SUMMARY OF THE INVENTION

Accordingly, the present invention is directed to an XML database duplicating apparatus for copying an XML document to a remote server without loss of structure and attribute information of the XML document and the method thereof, which substantially obviates one or more problems due to limitations and disadvantages of the related art.

It is an object of the present invention to provide an XML database duplicating apparatus for copying an XML document to a remote server without loss of structure and attribute information of the XML document and the method thereof that can copy XML data managed by an original database to other servers physically different without loss of not only the original contents of the document but also meanings of the structure and attribute information that the XML document contains.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In order to achieve the above object, there is provided an extensible markup language (XML) database duplicating apparatus for copying an XML document to a remote server without loss of structure and attribute information of the XML document, comprising an original server for processing and transmitting only changed information of persistent classes of the XML document subject to duplication if a change of XML documents happens in an original database by a client application program, and at least one copied server for maintaining synchronization by applying the changed information transmitted from the original server to persistent classes of a copied database.

In another aspect of the present invention, there is provided an extensible markup language (XML) database duplicating method for copying an XML document to a remote server without loss of structure and attribute information of the XML document in order to copy XML documents stored in the XML database having a schema-dependent storage structure of a specified server to a database of other servers physically different, the method comprising a first step of an original server defining an XML schema subject to replication in an original server, and defining internal tables corresponding to the schema, a second step of the original server recording a change log if insertion, deletion and change operations of the XML document are produced by a user, a third step of the original server constructing a transmission buffer from an update log database in order to transmit changed items to a copied server, a fourth step of the copied server processing change operations as a single transaction in order to reflect the optimized changed items, and a fifth step of the copied server reflecting the changed original XML document in a copied database as maintaining the structure and attribute information with respect to the changed original XML document.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating an XML document storage structure of an XML database having a schema-dependent storage structure according to an embodiment of the present invention.

FIG. 2 is a schematic block diagram of an XML database duplicating apparatus for copying an XML document to a remote server without loss of structure and attribute information of the XML document according to an embodiment of the present invention.

FIG. 3 is a detailed block diagram of an XML database duplicating apparatus for copying an XML document to a remote server without loss of structure and attribute information of the XML document according to an embodiment of the present invention.

FIG. 4 is a view illustrating a table for managing XML schema defined in the original server of FIG. 3.

FIG. 5 is a view illustrating a table for expressing persistent classes that belong to XML schema defined as an object of replication in FIG. 4.

FIG. 6 is a view illustrating a method of constructing a transmission buffer performed by an update log extractor of FIG. 3.

FIG. 7 is a view illustrating a method of reflecting information updated by an updated log extractor of FIG. 3 in a copied database.

### DETAILED DESCRIPTION OF THE PREFERRED EMBODIMENT

The XML database duplicating apparatus for copying an XML document to a remote server without loss of structure and attribute information of the XML document and the method thereof according to the preferred embodiment of the present invention will now be explained in detail with reference to the accompanying drawings.

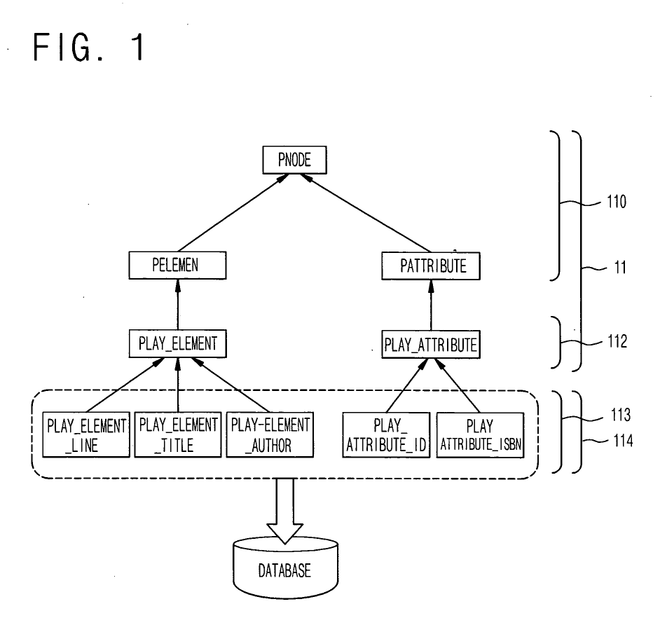

FIG. 1 is a view illustrating an XML document storage structure of an XML database having a schema-dependent storage structure according to an embodiment of the present invention.

Generally, in order to store an XML document in a relation type or object-relation type database, a storage table or storage classes for storing the XML document in the database are created. The created classes are classified as follows in accordance with dependency of a DTD or XML schema: Generic classes 100 are storage classes created independently of the XML schema, and schema generic classes 112 are storage classes that are created dependent on the name of the XML schema, but are independent of schema constituent elements. Schema-dependent classes 113 are storage classes created dependent on the name of the XML schema and the schema constituent elements. Also, according to the classification according to whether such classes actually have physical objects in the database, virtual classes 111 are storage classes for defining a general attribute and succeeding the defined attribute to persistent classes, and have no actual object. The persistent classes 114 are storage classes for actually storing the structure and the contents of the XML document in the database.

According to the XML database duplicating method according to the present invention, in order for one XML document stored in the original database in the structure of classes that express the XML document to maintain its structure and attribute even in a copied database of another server, the persistent classes 114 are defined as a set of objects of duplication, and the database consistency between the original server and the copied server is maintained through the management of their changed items. This is because the changed items of the persistent classes 114 having physical substances should be managed in order to prevent the loss of the structure and attribute information of the XML document since the virtual classes 111 are not physical substances to be actually stored in the database, but are information managed in a memory as needed on the basis of the persistent classes 114.

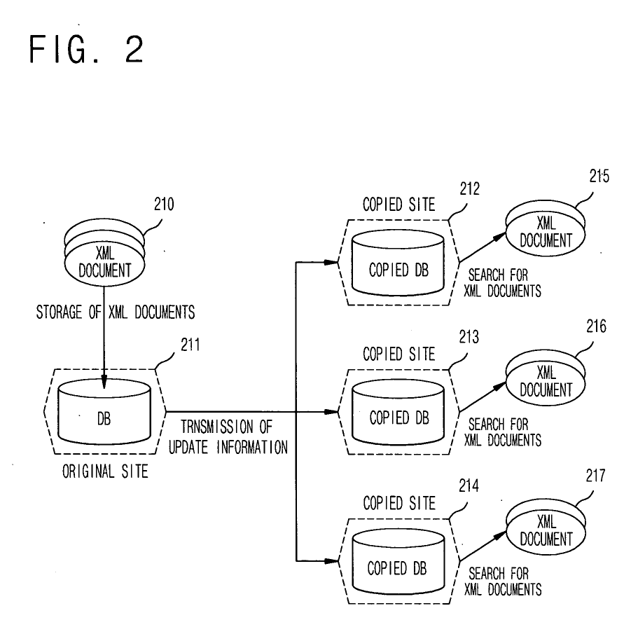

FIG. 2 is a schematic block diagram of an XML database duplicating apparatus for copying an XML document to a remote server without loss of structure and attribute information of the XML document according to an embodiment of the present invention.

The XML database duplicating apparatus according to the embodiment of the present invention includes, in the environment that computing systems for operating a database management process exist, an original site 211 for performing insertion, deletion and change operation with respect to an XML document 210, and a plurality of copied sites 212 to 214 for providing a search operation with respect to the XML document by using the same data as that in an original database of the original site 211.

The operation of the XML database duplicating apparatus as constructed above according to the embodiment of the present invention will now be explained in detail.

First, if a change of the XML documents happens in the original database by a client application program, a process in charge of the replication processes only changed information of the persistent classes 114 of the XML document subject to duplication, and transmits the changed information to copied databases of the copied sites 212 to 214. Thereafter, the copied sites 212 to 214 maintain the synchronization with the original site 211 by applying the changed information received from the original site 211 to the persistent classes 114 of the copied databases.

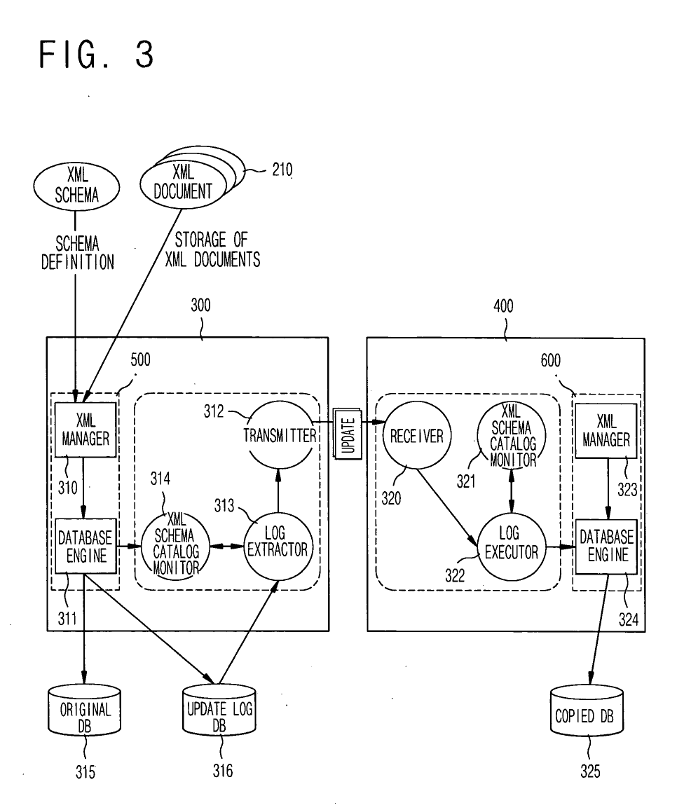

FIG. 3 is a detailed block diagram of an XML database duplicating apparatus for copying an XML document to a remote server without loss of structure and attribute information of the XML document according to an embodiment of the present invention.

As shown in FIG. 3, the XML database duplicating apparatus for copying an XML document to a remote server without loss of structure and attribute information of the XML document includes an original server 300 for processing and transmitting only changed information of persistent classes of the X document subject to duplication if a change of XML documents happens in an original database by a client application program, and a copied server 400 for maintaining synchronization with the original server 300 by applying the changed information transmitted from the original server 300 to persistent classes of a copied database.

The original server 300 includes an XML manager 310, an XML schema catalog monitor 314, a database engine 311 for storing the XML document in the original database 315 and then storing information of persistent classes defined by the XML schema catalog monitor 314 in an update log database 316 if a change of the XML document happens, an update log extractor 313 for constructing a transmission buffer by processing the information of the persistent classes stored in the update log database 316, and a transmitter 312 for transmitting the transmission buffer constructed by the update log extractor 313 to the copied server 400.

The copied server 400 includes a receiver 320 for receiving the transmission buffer transmitted from the original server, an update log executor 322 for considering the received transmission buffer as a single transaction and reflecting the transmission buffer in the copied database, an XML schema catalog monitor 321, an XML manager 323, and a database engine 324.

The operation of the XML database duplicating apparatus as constructed above according to the embodiment of the present invention will now be explained in detail.

First, if a change of the XML document happens in the original server 300, the database engine 311 stores the XML document in the original database 315, and then stores the information of the persistent classes defined by the XML schema catalog monitor 314 in the update log database 316. Then the update log extractor 313 processes the changed information stored in the update log database 316 and transfers the processed information to the receiver of the copied server 400. The copied server 400 reflects the transferred persistent classes in the copied database 325 using the change log executor 322.

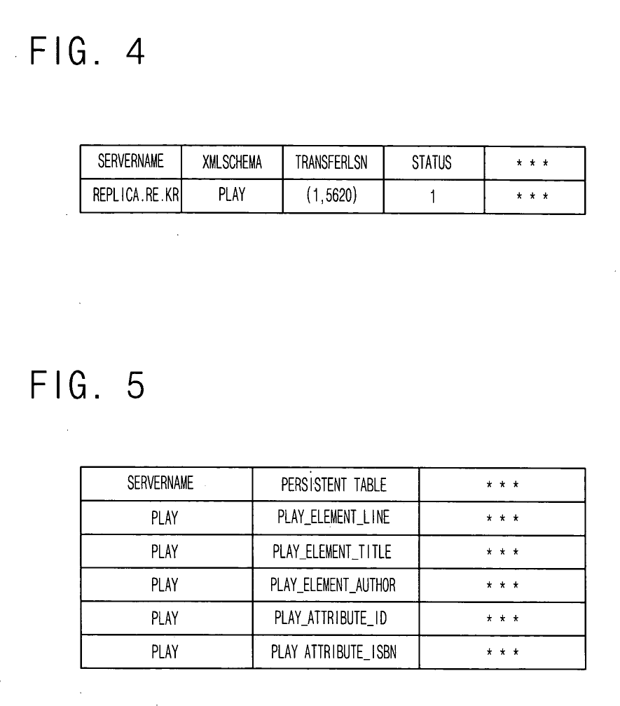

FIG. 4 is a view illustrating a table for managing XML schema defined in the original server of FIG. 3.

As shown in FIG. 4, combination of a name space of the XML schema and a file name of an XML schema document file are uniquely defined in the database, and the uppermost concept of an object that copies the XML database of the original server to another server is defined as the XML schema. Accordingly, in order to manage the XML document to be copied, an address of a copied server ServerName, an XML schema name XMLSchema, log position information TransferLSN finally reflected in the copied server, status information Status, and so on are essentially required.

FIG. 5 is a view illustrating a table for expressing persistent classes that belong to XML schema defined as an object to be copied in FIG. 4.

As shown in FIG. 5, information of the persistent classes belonging to the XML schema subject to replication is recorded, and then a change happening in classes recorded in the table is detected and reflected in the copied server.

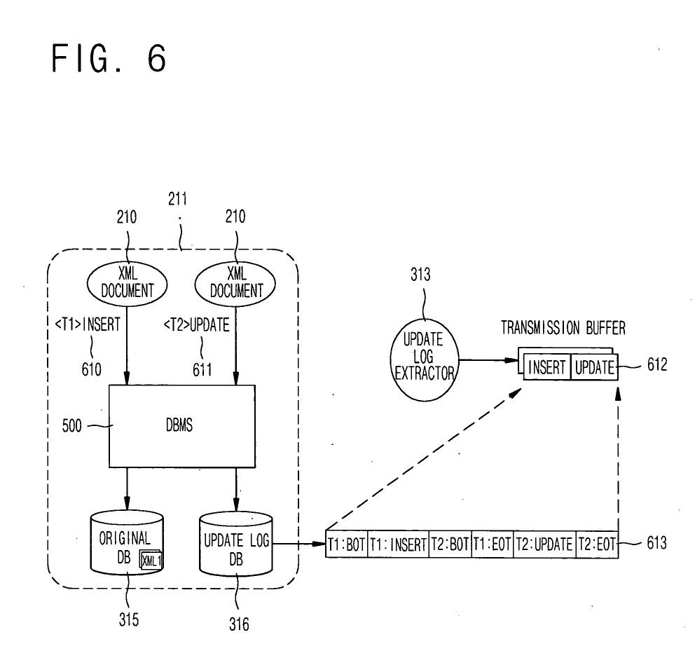

FIG. 6 is a view illustrating a method of constructing a transmission buffer performed by an update log extractor of FIG. 3.

As shown in FIG. 6, a transaction Ti performs an insertion of the XML document, and a transaction T2 performs a change of the XML document previously stored. At this time, if the XML document to be changed is a document that follows the XML schema registered in the table of FIG. 4, it means that the document is subject to replication, and thus the changed information of the persistent classes is recorded in the update log database 316 to reflect the change operation in the copied server 300 (613). Thereafter, the transmission buffer 612 to be sent to the copied server 400 is constructed by the update log extractor 313 in a manner that only the log that contains the actual changed information is extracted in the order of transaction in order to optimize the efficiency of transmission to the network.

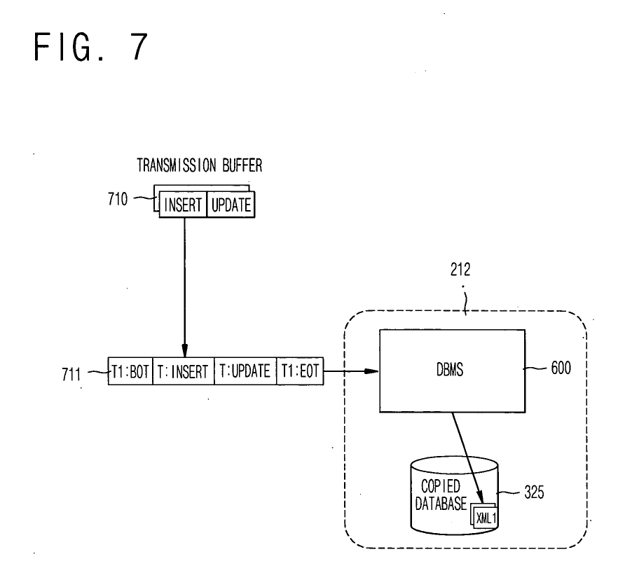

FIG. 7 is a view illustrating a method of reflecting information updated by an updated log extractor of FIG. 3 in a copied database.

As shown in FIG. 7, if the information changed by a plurality of transactions is processed by the update log extractor 313 of the original server 300 and then transferred to the copied server 400, the update log executor 322 of the copied server 400 considers the transmitted buffer 710 as a single transaction and reflects the transmitted buffer in the copied database 325. If all of the change operations of the transmission buffer are processed as individual transactions, the information on the finally performed operation should always be tracked in order to maintain the consistency in the case that a transaction error or a system error occurs, and this is inefficient. In order to solve this problem, according to the present invention, since the operations of the transmission buffer are processed as a single transaction, a prompt reflection of the changed information to the copied database can be obtained, and an additional amount of work to be processed by way of precaution against various kinds of error occurrence can be reduced. Also, if the reflection of the changed information in the copied database is completed, whether the reflection succeeds is notified to the original server in order to prevent the problem of retransmission and so on due to a network error or the like.

As described above, according to the present invention, the XML database is copied to a database of another server physically different without loss of not only the original contents of the XML document but also the structure and attribute information of the document, and thus the respective copied servers can not only support the searches based on the contents and the attribute provided by an XML query language but also disperse users' queries concentrated to the original server to a plurality of copied servers, so that the quality of service can be greatly improved.

While the present invention has been described and illustrated herein with reference to the preferred embodiment thereof, it will be understood by those skilled in the art that various changes and modifications may be made to the invention without departing from the spirit and scope of the invention, which is defined in the appended claims.

1. An extensible markup language (XML) database duplicating apparatus for copying an XML document to a remote server without loss of structure and attribute information of the XML document, the apparatus comprising:
an original server for processing and transmitting only changed information of persistent classes of the XML document subject to duplication if a change of XML documents happens in an original database by a client application program; and
at least one copied server for maintaining synchronization by applying the changed information transmitted from the original server to persistent classes of a copied database.

2. The apparatus as claimed in claim 1, wherein the original server comprises:
a database engine for storing the XML document in the original database and then storing information of persistent classes defined by an XML schema catalog monitor in an update log database if a change of the XML document happens;
an update log extractor for constructing a transmission buffer by processing the information of the persistent classes stored in the update log database; and
a transmitter for transmitting the transmission buffer constructed by the update log extractor to the copied server.

3. The apparatus as claimed in claim 1, wherein the copied server comprises:
a receiver for receiving the transmission buffer transmitted from the original server; and
an update log executor for considering the received transmission buffer as a single transaction and reflecting the transmission buffer in the copied database.

4. An extensible markup language (XML) database duplicating method for copying an XML document to a remote server without loss of structure and attribute information of the XML document in order to copy XML documents stored in the XML database having a schema-dependent storage structure of a specified server to a database of other servers physically different, the method comprising:
a first step of an original server defining an XML schema subject to replication in an original server, and defining internal tables corresponding to the schema;
a second step of the original server recording a change log if insertion, deletion and change operations of the XML document are produced by a user;
a third step of the original server constructing a transmission buffer from an update log database in order to transmit changed items to a copied server;
a fourth step of the copied server processing change operations as a single transaction in order to reflect the optimized changed items; and
a fifth step of the copied server reflecting the changed original XML document in a copied database as maintaining the structure and attribute information with respect to the changed original XML document.

5. The method as claimed in claim 4, wherein when the original server defines the XML documents subject to replication, the original server uses the XML schema that describes the structure of the XML documents as an uppermost unit of objects of replication.

6. The method as claimed in claim 4, wherein when the original server records the changed XML document in the update log, the original server constructs information of an actual physical table to be copied by using persistent classes that follow the defined XML schema.

7. The method as claimed in claim 4, wherein when the original server changes the XML document, the original server verifies whether the XML document is and XML document that follows the defined XML schema, and records the change operation of the verified XML document in the update log database.

8. The method as claimed in claim 4, wherein when the original server records a change log, the original server records only the change of the persistent classes among classes that constitute the XML document in the update log database.

9. The method as claimed in claim 4, wherein the original server constructs the transmission buffer to be transferred to the copied server, the original server extracts changed items after a finally transmitted log position, remove the logs of begin-of-transaction and end-of-transaction types from the extracted logs in order to optimize a network transmission efficiency, and constructing the transmission buffer in the order of transaction performed.

10. The method as claimed in claim 4, wherein when the copied server executes the transmitted update log, the copied server considers the transmitted update log as a single transaction irrespective of whether the transmitted update log is a result from a plurality of transactions, and reflects the transmitted update log in the copied database.
